(19) United States
(12) Patent Application Publication
(10) Pub. No.: US 2024/0154161 A1
(43) Pub. Date: May 9, 2024

(54) ALL SOLID BATTERY

(71) Applicant: TAIYO YUDEN CO., LTD., Tokyo (JP)

(72) Inventor: Takato SATO, Tokyo (JP)

(73) Assignee: TAIYO YUDEN CO., LTD., Tokyo (JP)

(21) Appl. No.: 18/493,354

(22) Filed: Oct. 24, 2023

(30) Foreign Application Priority Data
Nov. 9, 2022 (JP) 2022-179705

(51) Int. Cl. H01M 10/0562; H01M 10/052; H01M 10/28

(52) U.S. Cl. CPC H01M 10/0562; H01M 10/052; H01M 10/281; H01M 50/133

(57) ABSTRACT

An all solid battery includes a multilayer portion in which each of a plurality of solid electrolyte layers and each of a plurality of internal electrode layers including an electrode active material are alternately stacked, and an exterior portion that covers at least a part of the multilayer portion and includes an inner layer arranged on a side of the multilayer portion and an outer layer arranged opposite to the multilayer portion. The inner layer and the outer layer include a filler material. An area ratio of the filler material in the outer layer is lower than an area ratio of the filler material in the inner layer, in a cross section including a stacking direction.

### CROSS-REFERENCE TO RELATED APPLICATION

This application is based upon and claims the benefit of priority of the prior Japanese Patent Application No. 2022-179705, filed on Nov. 9, 2022, the entire contents of which are incorporated herein by reference.

### FIELD

A certain aspect of the present invention relates to an all solid battery.

### BACKGROUND

Stacked all solid batteries are safe and easy-to-handle secondary batteries that do not have to worry about fire or leakage, and can be reflow-soldered (see, for example, International Publication No. 2018/186449, International Publication No. 2020/070989, International Publication No. 2021/070927, and Japanese Patent Application Publication No. 2017-182945). A transition from conventional lithium-ion batteries using liquid electrolyte is being considered, and it is expected that they will be used in a wide range of fields.

### SUMMARY OF THE INVENTION

According to an aspect of the present invention, there is provided an all solid battery including: a multilayer portion in which each of a plurality of solid electrolyte layers and each of a plurality of internal electrode layers including an electrode active material are alternately stacked; and an exterior portion that covers at least a part of the multilayer portion and includes an inner layer arranged on a side of the multilayer portion and an outer layer arranged opposite to the multilayer portion, wherein the inner layer and the outer layer include a filler material, wherein an area ratio of the filler material in the outer layer is lower than an area ratio of the filler material in the inner layer, in a cross section including a stacking direction.

### BRIEF DESCRIPTION OF THE DRAWINGS

FIG. 1 illustrates a schematic cross sectional view of a basic structure of an all solid battery;

FIG. 2 illustrates a schematic partial cross-sectional perspective view of a stacked all-solid-state battery in which battery units are stacked;

FIG. 3 illustrates a cross sectional view taken along a line A-A of FIG. 2;

FIG. 4 illustrates a cross sectional view taken along a line B-B of FIG. 2;

FIG. 5A illustrates a enlarged view of a cross section of a side margin;

FIG. 5B illustrates an enlarged view of a cross section of a first end margin;

FIG. 6 illustrates a schematic cross sectional view of an exterior portion;

FIG. 7 illustrates a flowchart of a manufacturing method of an all solid battery;

FIG. 8A and FIG. 8B illustrate a stacking process; and

FIG. 9 illustrates a stacking process.

### DETAILED DESCRIPTION

In such an all solid battery, cracks may occur due to volumetric expansion and contraction of an electrode active material during charging and discharging. If suppression of the cracks is tried, there is a risk that outside air will enter the interior.

A description will be given of an embodiment with reference to the accompanying drawings.

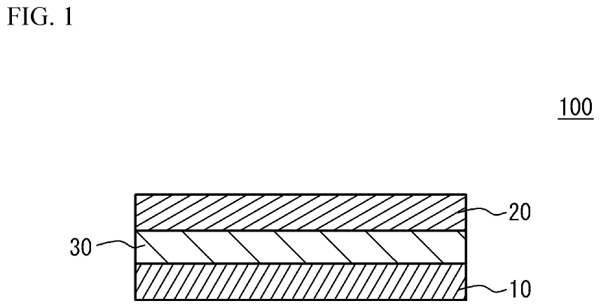

(Embodiment) FIG. 1 illustrates a schematic cross sectional view of a basic structure of an all solid battery 100 in accordance with an embodiment. As illustrated in FIG. 1, the all solid battery 100 has a structure in which a first internal electrode layer 10 and a second internal electrode layer 20 sandwich a solid electrolyte layer 30. The first internal electrode layer 10 is provided on a first main face of the solid electrolyte layer 30. The second internal electrode layer 20 is provided on a second main face of the solid electrolyte layer 30. For example, the first internal electrode layer 10, the second internal electrode layer 20 and the solid electrolyte layer 30 have a sintered body which is formed by sintering powder materials.

When the all solid battery 100 is used as a secondary battery, one of the first internal electrode layer 10 and the second internal electrode layer 20 is used as a positive electrode and the other is used as a negative electrode. In the embodiment, as an example, the first internal electrode layer 10 is used as a positive electrode, and the second internal electrode layer 20 is used as a negative electrode.

A main component of the solid electrolyte layer 30 is an oxide-based solid electrolyte having a NASICON crystal structure and having ion conductivity. For example, phosphoric acid salt-based electrolyte having a NASICON structure may be used for the solid electrolyte layer 30. The phosphoric acid salt-based solid electrolyte having the NASICON crystal structure has a high conductivity and is stable in normal atmosphere. The phosphoric acid salt-based solid electrolyte is, for example, such as a salt of phosphoric acid including lithium. The phosphoric acid salt is not limited. For example, the phosphoric acid salt is such as composite salt of phosphoric acid with Ti (for example LiTi₂(PO₄)₃). Alternatively, at least a part of Ti may be replaced with a transition metal of which a valence is four, such as Ge, Sn, Hf, or Zr. In order to increase an amount of Li, a part of Ti may be replaced with a transition metal of which a valence is three, such as Al, Ga, In, Y or La. In concrete, the phosphoric acid salt including lithium and having the NASICON structure is Li₁₊ₓAlₓGe₂₋ₓ(PO₄)₃, Li₁₊ₓAlₓZr₂₋ₓ(PO₄)₃, Li₁₊ₓAlₓT₂₋ₓ(PO₄)₃ or the like. For example, it is preferable that Li—Al—Ge—PO₄-based material, to which a transition metal included in the phosphoric acid salt having the olivine type crystal structure included in the first internal electrode layer 10 and the second internal electrode layer 20 is added in advance, is used. For example, when the first internal electrode layer 10 and the second internal electrode layer 20 include phosphoric acid salt including Co and Li, it is preferable that the solid electrolyte layer 30 includes Li—Al—Ge—PO₄-based material to which Co is added in advance. In this case, it is possible to suppress solving of the transition metal included in the electrode active material into the electrolyte. When the first internal electrode layer 10 and the second internal electrode layer 20 include phosphoric acid salt including Li and a transition metal other than Co, it is preferable that the solid electrolyte layer 30 includes Li—Al—Ge—PO₄-based material in which the transition metal is added in advance.

At least, the first internal electrode layer 10 used as the positive electrode includes a material having an olivine type crystal structure, as an electrode active material. It is preferable that the second internal electrode layer 20 also includes the electrode active material. The electrode active material is such as phosphoric acid salt including a transition metal and lithium. The olivine type crystal structure is a crystal of natural olivine. It is possible to identify the olivine type crystal structure, by using X-ray diffraction.

For example, LiCoPO₄ including Co may be used as a typical example of the electrode active material having the olivine type crystal structure. Other salts of phosphoric acid, in which Co acting as a transition metal is replaced to another transition metal in the above-mentioned chemical formula, may be used. A ratio of Li or PO₄ may fluctuate in accordance with a valence. It is preferable that Co, Mn, Fe, Ni or the like is used as the transition metal.

The electrode active material having the olivine type crystal structure acts as a positive electrode active material in the first internal electrode layer 10 acting as the positive electrode. For example, when only the first internal electrode layer 10 includes the electrode active material having the olivine type crystal structure, the electrode active material acts as the positive electrode active material. When the second internal electrode layer 20 also includes an electrode active material having the olivine type crystal structure, discharge capacity may increase and an operation voltage may increase because of electric discharge, in the second internal electrode layer 20 acting as the negative electrode. The function mechanism is not completely clear. However, the mechanism may be caused by partial solid-phase formation together with the negative electrode active material.

When both the first internal electrode layer 10 and the second internal electrode layer 20 include an electrode active material having the olivine type crystal structure, the electrode active material of each of the first internal electrode layer 10 and the second internal electrode layer 20 may have a common transition metal. Alternatively, the a transition metal of the electrode active material of the first internal electrode layer 10 may be different from that of the second internal electrode layer 20. The first internal electrode layer 10 and the second internal electrode layer 20 may have only single type of transition metal. The first internal electrode layer 10 and the second internal electrode layer 20 may have two or more types of transition metal. It is preferable that the first internal electrode layer 10 and the second internal electrode layer 20 have a common transition metal. It is more preferable that the electrode active materials of the both electrode layers have the same chemical composition. When the first internal electrode layer 10 and the second internal electrode layer 20 have a common transition metal or a common electrode active material of the same composition, similarity between the compositions of the both electrode layers increases. Therefore, even if terminals of the all solid battery 100 are connected in a positive/negative reversed state, the all solid battery 100 can be actually used without malfunction, in accordance with the usage purpose.

The second internal electrode layer 20 may include known material as the negative electrode active material. When only one of the electrode layers includes the negative electrode active material, it is clarified that the one of the electrode layers acts as a negative electrode and the other acts as a positive electrode. When only one of the electrode layers includes the negative electrode active material, it is preferable that the one of the electrode layers is the second internal electrode layer 20. Both of the electrode layers may include the known material as the negative electrode active material. Conventional technology of secondary batteries may be applied to the negative electrode active material. For example, titanium oxide, lithium-titanium complex oxide, lithium-titanium complex salt of phosphoric acid salt, a carbon, a vanadium lithium phosphate.

In the forming process of the first internal electrode layer 10 and the second internal electrode layer 20, moreover, oxide-based solid electrolyte material or a conductive material (conductive auxiliary agent) may be added. When the material is evenly dispersed into water or organic solution together with binder or plasticizer, paste for electrode layer is obtained. In the embodiment, the electrode layer paste includes a carbon material as the conductive auxiliary agent. Moreover, the electrode may include a metal as the conductive auxiliary agent. Pd, Ni, Cu, or Fe, or an alloy thereof may be used as a metal of the conductive auxiliary agent. The solid electrolyte included in the first internal electrode layer 10 and the second internal electrode layer 20 may be the same as the solid electrolyte which is the main component of the solid electrolyte layer 30.

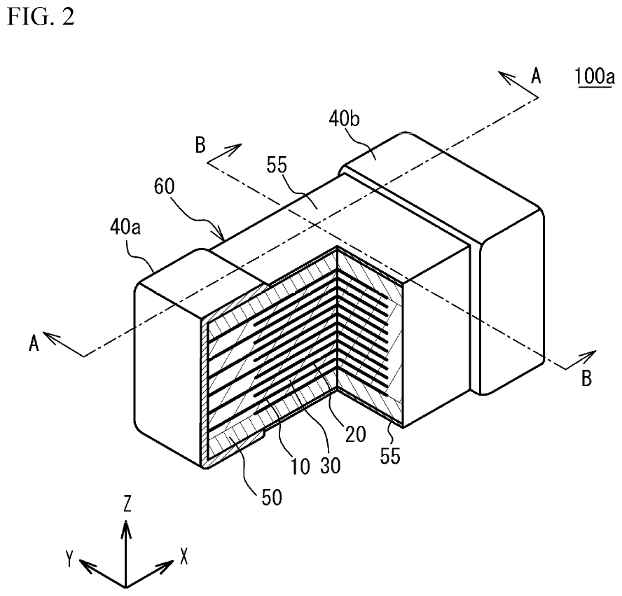

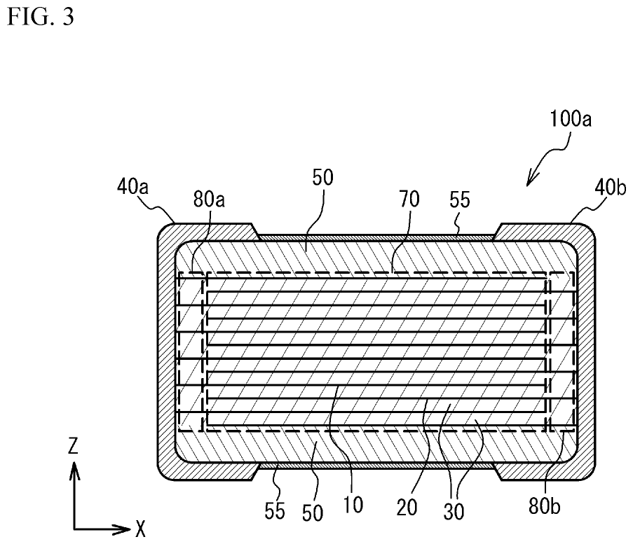

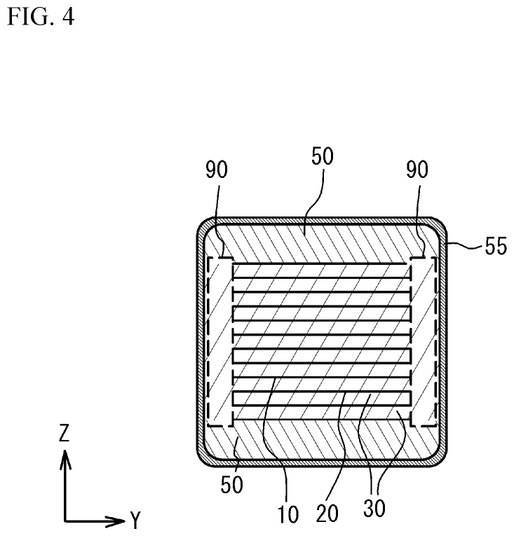

FIG. 2 is a partial cross-sectional perspective view of a stacked all-solid-state battery 100a in which a plurality of battery units are stacked. FIG. 3 is a cross-sectional view taken along a line A-A in FIG. 2. FIG. 4 is a sectional view taken along a line B-B in FIG. 2. The all solid battery 100a includes a multilayer chip 60 having a substantially rectangular parallelepiped shape. In the multilayer chip 60, a first external electrode 40a and a second external electrode 40b are provided so as to be in contact with two side faces, which are two of the four faces other than the upper face and the lower face at the ends in the stacking direction. The two side faces may be two adjacent side faces or may be two side faces facing each other. In this embodiment, it is assumed that the first external electrode 40a and the second external electrode 40b are provided so as to be in contact with the two side faces (hereinafter referred to as two end faces) facing each other.

In FIG. 2 to FIG. 4, the X-axis direction is the direction in which the two end faces of the multilayer chip 60 face each other, and the direction in which the first external electrode 40a and the second external electrode 40b face each other. The Y-axis direction is the width direction of the first internal electrode layer 10 and the second internal electrode layer 20, and is the opposing direction in which two of the four side faces of the multilayer chip 60 other than the two end faces face each other. The Z-axis direction is the stacking direction, and is the direction in which the upper face and the lower face of the multilayer chip 60 face each other. The X-axis direction, the Y-axis direction, and the Z-axis direction are orthogonal to each other.

In the following description, the same numeral is added to each member that has the same composition range, the same thickness range and the same particle distribution range as that of the all solid battery 100. And, a detail explanation of the same member is omitted.

In the all solid battery 100a, the plurality of first internal electrode layers 10 and the plurality of second internal electrode layers 20 are alternately stacked with the solid electrolyte layers 30 in between. The edges of the plurality of first internal electrode layers 10 in the X-axis direction are exposed to the first end face of the multilayer chip 60 and are not exposed to the second end face. The edges of the plurality of second internal electrode layers 20 in the X-axis direction are exposed to the second end face of the multilayer chip 60 and are not exposed to the first end face. Thereby, the first internal electrode layer 10 and the second internal electrode layer 20 are alternately electrically connected to the first external electrode 40a and the second external electrode 40b. Note that the solid electrolyte layer 30 extends from the first external electrode 40a to the second external electrode 40b. In this way, the all solid battery 100a has a structure in which a plurality of battery units are stacked.

A cover layer 50 is stacked on the upper end surface of the stacked portion of the first internal electrode layer 10, the solid electrolyte layer 30 and the second internal electrode layer 20. The cover layer 50 is in contact with the uppermost internal electrode layer (either one of the first internal electrode layer 10 and the second internal electrode layer 20) and is in contact with part of the solid electrolyte layer 30. Another cover layer 50 is also stacked on the lower end surface of the stacked portion. The cover layer 50 is in contact with the lowermost internal electrode layer (either one of the first internal electrode layer 10 and the second internal electrode layer 20) and is in contact with part of the solid electrolyte layer 30. For example, the cover layer 50 is a sintered body obtained by sintering powder material.

Furthermore, in the multilayer chip 60, a protective layer 55 is provided on the outermost surface between the first external electrode 40a and the second external electrode 40b. For example, the protective layer 55 is a sintered body obtained by sintering powder material. Between the first external electrode 40a and the second external electrode 40b, the protective layer 55 covers the upper face of the upper cover layer 50, covers the lower face of the lower cover layer 50, and outer side faces of the solid electrolyte layer 30, a first margin layer 95a, and a second margin layer 95b.

As illustrated in FIG. 3, a section where the first internal electrode layer 10 connected to the first external electrode 40a and the second internal electrode layer 20 connected to the second external electrode 40b face each other produces a battery capacity. Therefore, the section is called a battery capacity section 70. That is, the battery capacity section 70 is the section where two adjacent internal electrode layers connected to different external electrodes face each other.

A section where the first internal electrode layers 10 connected to the first external electrode 40a face each other without interposing the second internal electrode layer 20 connected to the second external electrode 40b is referred to as a first end margin 80a. Further, a section where the second internal electrode layers 20 connected to the second external electrode 40b face each other without interposing the first internal electrode layer 10 connected to the first external electrode 40a is referred to as a second end margin 80b. That is, the end margin is a section where internal electrode layers connected to the same external electrode face each other without interposing an internal electrode layer connected to a different external electrode. The first end margin 80a and the second end margin 80b are sections that do not produce battery capacity.

As illustrated in FIG. 4, in the multilayer chip 60, the section from the two side faces of the multilayer chip 60 to the first internal electrode layers 10 and the second internal electrode layers 20 is referred to as a side margin 90. That is, the side margin 90 is a section provided so as to cover the ends of the plurality of stacked first internal electrode layers 10 and second internal electrode layers 20 extending toward the two side surfaces in the multilayer portion.

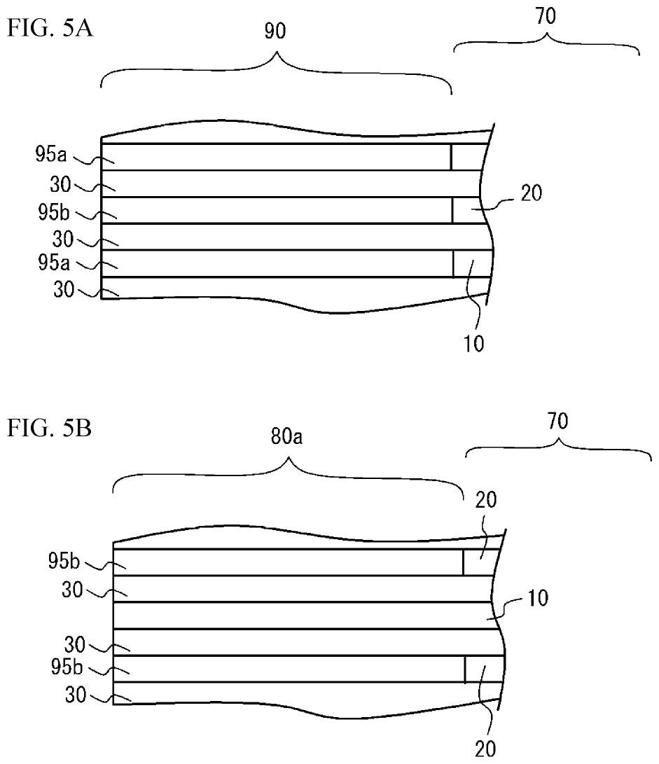

FIG. 5A is an enlarged cross sectional view of the side margin 90. The side margin 90 has a structure in which the solid electrolyte layers 30 and the margin layers are alternately stacked in the stacking direction of the first internal electrode layer 10 and the second internal electrode layer 20 in the battery capacity section 70. The first margin layer 95a is provided in the same layer as the first internal electrode layer 10. The second margin layer 95b is provided in the same layer as the second internal electrode layer 20. According to this configuration, the step between the battery capacity section 70 and the side margin 90 is suppressed.

FIG. 5B is an enlarged cross sectional view of the first end margin 80a. In comparison with the side margin 90, in the first end margin 80a, every other internal electrode layer among the plurality of stacked internal electrode layers extends to the end surface of the first end margin 80a. That is, in the first end margin 80a, the first internal electrode layer 10 extends to the end surface, and the second internal electrode layer 20 does not extend to the end surface. The second margin layer 95b is provided in the same layer as the second internal electrode layer 20. Further, in the layer where the first internal electrode layer 10 extends to the end surface of the first end margin 80a, the first margin layer 95a is not stacked. According to this configuration, the step between the battery capacity section 70 and the first end margin 80a is suppressed. Note that in the second end margin 80b, the second internal electrode layer 20 extends to the end surface, and the first internal electrode layer 10 does not extend to the end surface. In the second end margin 80b, the first margin layer 95a is provided in the same layer as the first internal electrode layer 10.

The cover layer 50, the first margin layer 95a, the second margin layer 95b, and the protective layer 55 have the function of suppressing the intrusion of outside air into the inside of the multilayer chip 60. The cover layer 50, the first margin layer 95a, the second margin layer 95b, and the protective layer 55 may be collectively referred to as an exterior portion. Furthermore, since the cover layer 50, the first margin layer 95a, and the second margin layer 95b are arranged on the inner side of the exterior part, they may be collectively referred to as an inner layer. In addition, since the protective layer 55 is arranged outside the inner layer, the protective layer 55 may be referred to as an outer layer.

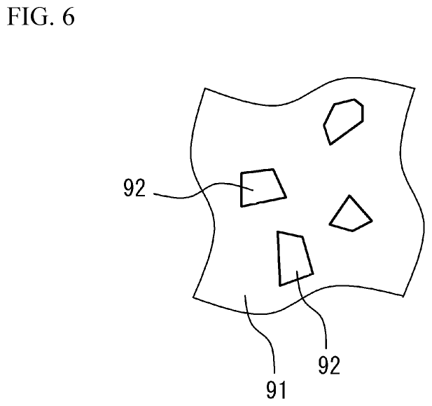

The exterior portion includes a matrix material 91 and a filler material 92, as illustrated in FIG. 6. The matrix material 91 forms a skeleton. A plurality of gaps are formed by this skeleton. The filler material 92 is placed in this gap. Therefore, the plurality of filler materials 92 are arranged in a spatially dispersed manner in the skeleton in which the matrix material 91 is spatially continuously formed. The filler material 92 is a crystalline material having a different composition from the matrix material 91.

Since the necking between the matrix materials 91 is strong, if the exterior portion is composed only of the matrix materials 91, breaking will occur when volumetric expansion and volumetric contraction of the electrode active material occur during charging and discharging. In this case, favorable cycle characteristic may not be necessarily secured. Since the necking between the matrix material 91 and the filler material 92 is not as strong as the necking between the matrix materials 91, even if the electrode active material undergoes volumetric expansion and volumetric contraction during charging and discharging, the displacement can be absorbed. However, the presence of the filler material 92 reduces the density, and there is a risk that outside air may enter.

Therefore, in this embodiment, the ratio of the filler material 92 is varied depending on the part of the exterior portion. The ratio of the filler material 92 is the area ratio of the filler material 92/(the matrix material 91+the filler material) in a cross section including the stacking direction. Specifically, the ratio of the filler material 92 in the protective layer 55 is made lower than the ratio of the filler material 92 in the cover layer 50, the first margin layer 95a, and the second margin layer 95b.

In this configuration, since a large amount of the filler material 92 is added to the inner layer of the exterior portion, the low-adhesion region between the matrix material 91 and the filler material 92 increases. As a result, even if the electrode active material undergoes volumetric expansion and volumetric contraction during charging and discharging, the inner layer of the exterior portion can be easily deformed, and the occurrence of cracks can be suppressed.

Since the amount of the filler material 92 added to the outer layer of the exterior portion is small, the density is high, and the intrusion path of outside air is reduced. Thereby, the moisture resistance of the outer layer of the exterior portion is improved.

As described above, according to the present embodiment, it is possible to suppress the occurrence of cracks while suppressing the intrusion of outside air.

In order to facilitate deformation of the inner layer of the exterior portion, it is preferable to set a lower limit to the ratio of the filler material 92 in the inner layer of the exterior portion. In this embodiment, the ratio of the filler material 92 in the cover layer 50, the first margin layer 95a, and the second margin layer 95b is preferably 30% or more, more preferably 40% or more, and still more preferably 50% or more.

On the other hand, if the ratio of the filler material 92 in the inner layer of the exterior portion is too high, outside air may enter. Therefore, it is preferable to set an upper limit on the ratio of the filler material 92 in the inner layer of the exterior portion. In this embodiment, the ratio of the filler material 92 in the cover layer 50, the first margin layer 95a, and the second margin layer 95b is preferably 90% or less, more preferably 80% or less, and still more preferably 70% or less.

In order to provide sufficient density to the outer layer of the exterior portion, it is preferable to set an upper limit to the ratio of the filler material 92 in the outer layer of the exterior portion. In this embodiment, the ratio of the filler material 92 in the protective layer 55 is preferably 40% or less, more preferably 25% or less, and even more preferably 10% or less.

For example, the matrix material 91 is preferably a material that easily causes necking and forms the skeleton when firing the all solid battery 100a. For example, as the matrix material 91, a glass material, an oxide-based solid electrolyte material, or the like can be used. From the viewpoint of adhesion of the cover layer 50, the first margin layer 95a, and the second margin layer 95b, it is preferable that the matrix material 91 has a common structure with the oxide-based solid electrolyte which is the main component of the solid electrolyte layer 30, the oxide-based solid electrolyte included in the first internal electrode layer 10m and the oxide-based solid electrolyte included in the second internal electrode layer 20. For example, it is preferable that the matrix material 91 has a NASICON type crystal structure. Moreover, the matrix material 91 preferably has the same composition as the oxide-based solid electrolyte that is the main component of the solid electrolyte layer 30. Moreover, the matrix material 91 preferably has the same composition as the solid electrolyte contained in the first internal electrode layers 10. Moreover, the matrix material 91 preferably has the same composition as the solid electrolyte contained in the second internal electrode layers 20. As the matrix material 91, for example, a Li—Al—Ge—PO₄-based material (LAGP), Li—Al—Zr—PO₄, Li—Al—Ti—PO₄, or the like can be used.

Alternatively, the matrix material 91 is preferably an insulating glass material. For example, as the matrix material 91, it is preferable to use Zn—Si—B—O-based glass, Li—Al—Ge—PO₄-based glass, Li—Si—B—O-based glass, or the like.

The filler material 92 is preferably a material that is less likely to cause necking than the matrix material 91 when firing the all solid battery 100a. For example, it is preferable to use alumina, silica, magnesia, titania or the like as the filler material 92.

The thickness of each of the protective layers 55 in the Z-axis direction is, for example, 2 μm or more and 200 μm or less, 5 μm or more and 50 μm or less, and 10 μm or more and 20 μm or less. The thickness of each of the cover layers 50 in the Z-axis direction is, for example, 5 μm or more and 500 μm or less, 10 μm or more and 350 μm or less, and 20 μm or more and 200 μm or less. The respective thicknesses of the first margin layer 95a and the second margin layer 95b in the Y-axis direction are, for example, 10 μm or more and 500 μm or less, 25 μm or more and 400 μm or less, and 50 μm or more and 300 μm or less.

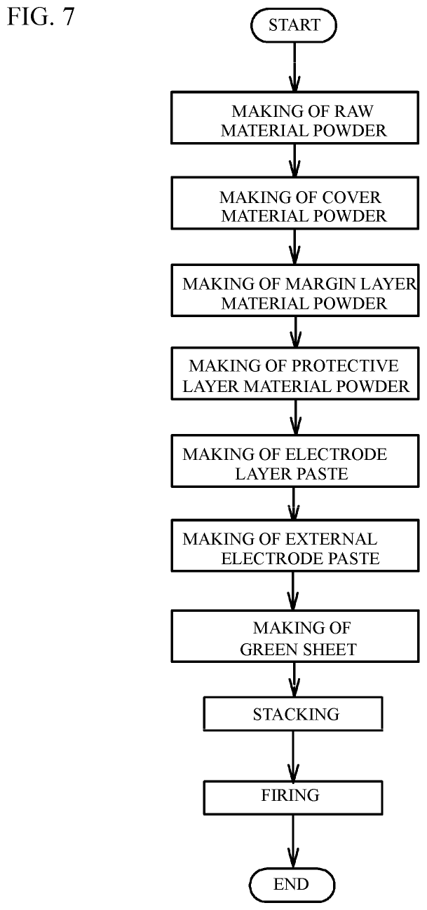

A description will be given of a manufacturing method of the all solid battery 100a described on the basis of FIG. 2. FIG. 7 illustrates a flowchart of the manufacturing method of the all solid battery 100a.

(Making process of war material powder for solid electrolyte layer) A raw material powder for the solid electrolyte for the solid electrolyte layer 30 is made. For example, it is possible to make the raw material powder for the oxide-based solid electrolyte, by mixing raw material and additives and using solid phase synthesis method or the like. The resulting powder is subjected to dry grinding. Thus, a particle diameter of the resulting power is adjusted to a desired one. For example, it is possible to adjust the particle diameter to the desired diameter with use of planetary ball mill using ZrO₂ ball of 5 mm ϕ.

(Making process of war material powder for cover layer) A raw material powder of ceramics for the cover layer 50 is made. For example, it is possible to make the raw material powder for the cover layer, by mixing raw material and additives and using solid phase synthesis method or the like. The resulting powder is subjected to dry grinding. Thus, a particle diameter of the resulting power is adjusted to a desired one. For example, it is possible to adjust the particle diameter to the desired diameter with use of planetary ball mill using ZrO₂ ball of 5 mm ϕ.

(Making process of raw material powder for margin layer) Raw material powders of the matrix material 91 and the filler material 92 that constitute the first margin layer 95a and the second margin layer 95b are made. As the matrix material 91, a material that is more likely to cause necking than the filler material 92 is used. For example, the raw material powder for the margin layer can be produced by mixing raw materials, additives, and the like and using a solid-phase synthesis method or the like. The resulting powder is subjected to dry grinding. Thus, a particle diameter of the resulting power is adjusted to a desired one. For example, it is possible to adjust the particle diameter to the desired diameter with use of planetary ball mill using ZrO₂ ball of 5 mm ϕ.

(Making process of war material powder for protective layer) A raw material powder of ceramics for the protective layer 55 is made. For example, it is possible to make the raw material powder for the protective layer, by mixing raw material and additives and using solid phase synthesis method or the like. The resulting powder is subjected to dry grinding. Thus, a particle diameter of the resulting power is adjusted to a desired one. For example, it is possible to adjust the particle diameter to the desired diameter with use of planetary ball mill using ZrO₂ ball of 5 mm ϕ.

(Making process for electrode layer paste) Next, internal electrode pastes for making the first internal electrode layer 10 and the second internal electrode layer 20 described above are separately made. For example, a paste for internal electrodes can be obtained by uniformly dispersing a conductive aid, an electrode active material, a solid electrolyte material, a sintering aid, a binder, a plasticizer and so on in water or an organic solvent. The solid electrolyte paste described above may be used as the solid electrolyte material. A carbon material or the like is used as a conductive aid. A metal may be used as the conductive aid. Examples of the metal of the conductive aid include Pd, Ni, Cu, Fe, and alloys containing these. Pd, Ni, Cu, Fe, alloys containing these, various carbon materials, and so on may also be used.

The additive includes sintering assistant. The sintering assistant includes one or more of glass components such as Li—B—O-based compound, Li—Si—O-based compound, Li—C—O-based compound, Li—S—O-based compound and Li—P—O-based compound.

(Making process of external electrode paste) Next, an external electrode paste for manufacturing the first external electrode 40a and the second external electrode 40b described above is made. For example, a paste for external electrodes can be obtained by uniformly dispersing a conductive material, glass frit, binder, plasticizer and so on in water or an organic solvent.

(Making process of solid electrolyte green sheet) By uniformly dispersing the raw material powder for the solid electrolyte layer in an aqueous or organic solvent together with a binder, dispersant, plasticizer and so on and performing wet pulverization, a solid electrolyte slurry having a desired average particle size can be made. At this time, a bead mill, a wet jet mill, various kneaders, a high-pressure homogenizer, or the like can be used, and it is preferable to use a bead mill from the viewpoint of being able to adjust the particle size distribution and perform dispersion at the same time. A binder is added to the obtained solid electrolyte slurry to obtain a solid electrolyte paste. A solid electrolyte green sheet 51 can be formed by applying the obtained solid electrolyte paste. The coating method is not particularly limited, and a slot die method, reverse coating method, gravure coating method, bar coating method, doctor blade method, or the like can be used. The particle size distribution after wet pulverization can be measured using, for example, a laser diffraction measuring device using a laser diffraction scattering method.

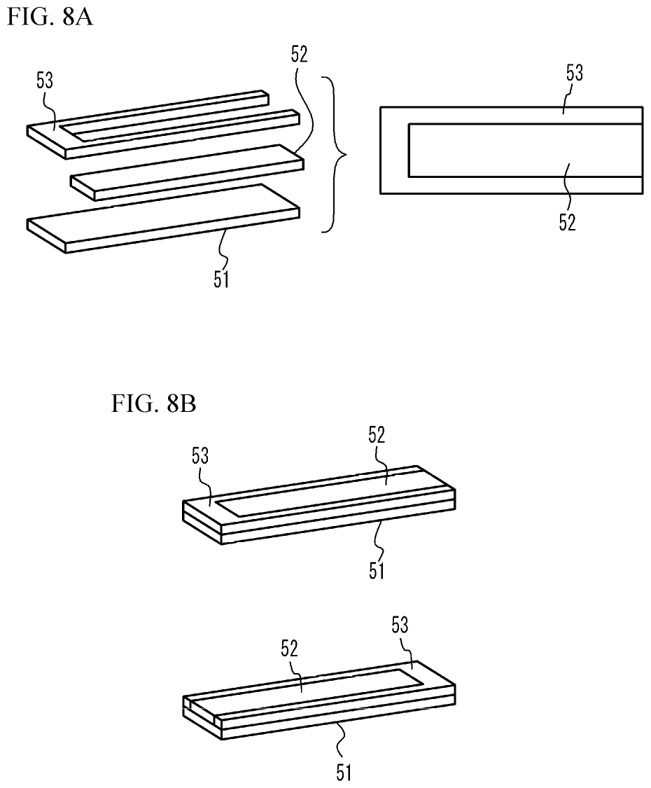

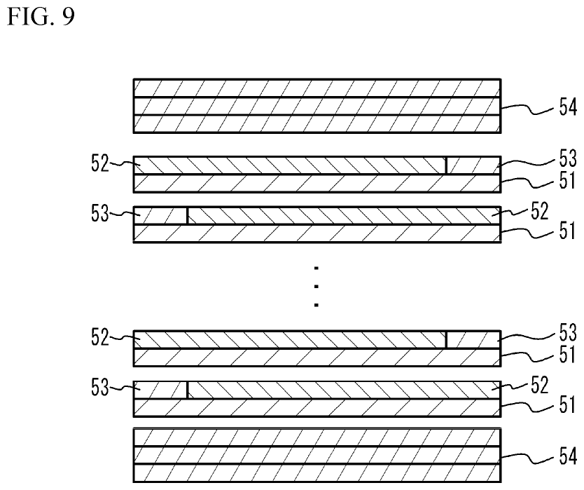

(Stacking process) As illustrated in FIG. 8A, an internal electrode paste 52 is printed on one side of the solid electrolyte green sheet 51. A margin layer paste 53 is printed on the peripheral area of the solid electrolyte green sheet 51 where the internal electrode paste 52 is not printed. The margin layer paste 53 can be formed by applying raw material powder for the margin layer using a method similar to the making process of the solid electrolyte green sheet. As illustrated in FIG. 8B, a plurality of printed solid electrolyte green sheets 51 are stacked so as to be alternately shifted. As illustrated in FIG. 9, a multilayer structure is obtained by pressing a cover sheet 54 from above and below in the stacking direction. In this case, in the multilayer structure, the internal electrode paste 52 for the first internal electrode layer 10 is exposed on one end surface, and the internal electrode paste 52 for the second internal electrode layer 20 is exposed on the other end surface. In this step, a green chip having a substantially rectangular parallelepiped shape is obtained. The cover sheet 54 can be formed by applying the raw material powder for the cover layer using a method similar to the making process of the solid electrolyte green sheet. The cover sheet 54 is formed thicker than the solid electrolyte green sheet 51. The thickness may be increased at the time of coating, or by stacking a plurality of coated sheets.

(Firing process) Next, the multilayer chip 60 is obtained by firing the obtained green chip. The firing conditions are not particularly limited, such as under an oxidizing atmosphere or a non-oxidizing atmosphere, with a maximum temperature of preferably 400° C. to 1000° C., more preferably 500° C. to 900° C. In order to sufficiently remove the binder before the maximum temperature is reached, a step of maintaining the temperature lower than the maximum temperature in an oxidizing atmosphere may be provided. In order to reduce process costs, it is desirable to fire at as low a temperature as possible. After firing, re-oxidation treatment may be performed. Thereafter, the first external electrode 40a and the second external electrode 40b are formed by applying and curing an external electrode paste on the two end surfaces of the multilayer chip 60. Thereafter, the protective layer 55 is formed by applying and baking a paste of raw material powder for the protective layer between the first external electrode 40a and the second external electrode 40b.

### EXAMPLES

(Example 1) A stacked all solid battery was produced according to the above embodiment. A first internal electrode paste for the first internal electrode layer (positive electrode layer) was applied onto the first solid electrolyte green sheet by screen printing. On the first solid electrolyte green sheet, the margin layer paste for the first margin layer was printed around the first internal electrode paste. A second internal electrode paste for the second internal electrode layer (negative electrode layer) was applied onto the second solid electrolyte green sheet by screen printing. On the second solid electrolyte green sheet, the margin layer paste for the second margin layer was printed around the second internal electrode paste. The first internal electrode paste for the positive electrode layer and the second internal electrode paste for the negative electrode layer were made to have the same thickness. A plurality of first solid electrolyte green sheets and a plurality of second solid electrolyte green sheets were stacked such that the positive electrode layers and the negative electrode layers were alternately pulled out to the left and right. The stack was cut into a predetermined size to obtain a green chip for the stacked all solid battery. The green chip was sintered by degreasing and firing, and an external electrode paste was applied and cured to form external electrodes, thereby obtaining the stacked all solid battery. The protective layer was formed by applying a protective layer paste between the external electrodes and baking the protective layer paste.

In Example 1, the ratio of the filler material in the protective layer was made lower than the ratio of the filler material in the cover layer, the first margin layer, and the second margin layer. Specifically, the ratio of the filler material in the protective layer was set to 10%, and the ratio of the filler material in the cover layer, the first margin layer, and the second margin layer was set to 40%.

(Example 2) Also in Example 2, the ratio of the filler material in the protective layer was made lower than the ratio of the filler material in the cover layer, the first margin layer, and the second margin layer. Specifically, the ratio of the filler material in the protective layer was set to 10%, and the ratio of the filler material in the cover layer, the first margin layer, and the second margin layer was set to 50%. Other conditions were the same as in Example 1.

(Example 3) Also in Example 3, the ratio of the filler material in the protective layer was made lower than the ratio of the filler material in the cover layer, the first margin layer, and the second margin layer. Specifically, the ratio of the filler material in the protective layer was set to 10%, and the ratio of the filler material in the cover layer, the first margin layer, and the second margin layer was set to 60%. Other conditions were the same as in Example 1.

(Example 4) Also in Example 4, the ratio of the filler material in the protective layer was made lower than the ratio of the filler material in the cover layer, the first margin layer, and the second margin layer. Specifically, the ratio of the filler material in the protective layer was set to 20%, and the ratio of the filler material in the cover layer, the first margin layer, and the second margin layer was set to 60%. Other conditions were the same as in Example 1.

(Comparative example 1) In Comparative Example 1, the ratio of the filler material in the protective layer was made higher than the ratio of the filler material in the cover layer, the first margin layer, and the second margin layer. Specifically, the ratio of the filler material in the protective layer was set to 50%, and the ratio of the filler material in the cover layer, the first margin layer, and the second margin layer was set to 10%. Other conditions were the same as in Example 1.

(Comparative example 2) Also in Comparative Example 2, the ratio of the filler material in the protective layer was made higher than the ratio of the filler material in the cover layer, the first margin layer, and the second margin layer. Specifically, the ratio of the filler material in the protective layer was set to 50%, and the ratio of the filler material in the cover layer, the first margin layer, and the second margin layer was set to 30%. Other conditions were the same as in Example 1.

(Comparative Example 3) Also in Comparative Example 3, the ratio of the filler material in the protective layer was made higher than the ratio of the filler material in the cover layer, the first margin layer, and the second margin layer. Specifically, the ratio of the filler material in the protective layer was set to 70%, and the ratio of the filler material in the cover layer, the first margin layer, and the second margin layer was set to 10%. Other conditions were the same as in Example 1.

(Comparative example 4) In Comparative Example 4, the ratio of the filler material in the protective layer was the same as the ratio of the filler material in the cover layer, the first margin layer, and the second margin layer. Specifically, the ratio of the filler material in the protective layer was set to 40%, and the ratio of the filler material in the cover layer, the first margin layer, and the second margin layer was set to 40%. Other conditions were the same as in Example 1.

(Presence or absence of cracks) For each of the all solid batteries of Examples 1 to 4 and Comparative Examples 1 to 4, the presence or absence of cracks was checked after the cycle test. In Examples 1 to 4, no cracking was observed. This is considered to be because the ratio of the filler material in the inner layer of the exterior portion was made smaller than the ratio of the filler material in the outer layer. In Comparative Examples 1 to 4, the occurrence of cracks was confirmed. This is considered to be because the ratio of the filler material in the inner layer of the exterior portion was made larger than or equal to the ratio of the filler material in the outer layer.

(Cycle characteristic test) A cycle characteristic test was conducted on each of the all solid batteries of Examples 1 to 4 and Comparative Examples 1 to 4. In the cycle characteristic test, a charge/discharge cycle test was conducted at 0.2C with an upper limit voltage of 3.3V and a lower limit voltage of 2.0V in a 25° C. environment.

Table shows the results. As a result of the cycle characteristic test, if the discharge capacity maintenance rate after 2000 cycles with respect to the 1st cycle was 85% or more and 100% or less, it is judged as passing “o”. If the discharged capacity maintenance rate was less than 85%, it is judged as slightly failing “x”. In Examples 1 to 4, the cycle characteristic test was judged to be passed “∘”. This is considered to be because the ratio of the filler material in the inner layer of the exterior portion was made smaller than the ratio of the filler material in the outer layer, thereby improving the density of the outer layer and suppressing the intrusion of outside air. In Comparative Examples 1 to 4, the cycle characteristics were determined to be failing “x”. This is considered to be because the ratio of the filler material in the inner layer of the exterior portion was made larger than or equal to the ratio of the filler material in the outer layer.

TABLE 1

| | RATIO OF FILLER MATERIAL | | | | |
|---|---|---|---|---|---|
| | COVER | MARGIN | PROTECTIVE | CYCLE | ABSENCE |
| | LAYER | LAYER | LAYER | CHARACTERISTIC | OF CRACK |
| EXAMPLE 1 | 40% | 40% | 10% | ∘ | NONE |
| EXAMPLE 2 | 50% | 50% | 10% | ∘ | NONE |
| EXAMPLE 3 | 60% | 60% | 10% | ∘ | NONE |
| EXAMPLE 4 | 60% | 60% | 20% | ∘ | NONE |
| COMPARATIVE | 10% | 10% | 50% | x | EXIST |
| EXAMPLE 1 | | | | | |
| COMPARATIVE | 30% | 30% | 50% | x | EXIST |
| EXAMPLE 2 | | | | | |
| COMPARATIVE | 10% | 10% | 70% | x | EXIST |
| EXAMPLE 3 | | | | | |
| COMPARATIVE | 40% | 40% | 40% | x | EXIST |
| EXAMPLE 4 | | | | | |

Although the embodiments of the present invention have been described in detail, it is to be understood that the various change, substitutions, and alterations could be made hereto without departing from the spirit and scope of the invention.

What is claimed is:

1. An all solid battery comprising:
a multilayer portion in which each of a plurality of solid electrolyte layers and each of a plurality of internal electrode layers including an electrode active material are alternately stacked; and
an exterior portion that covers at least a part of the multilayer portion and includes an inner layer arranged on a side of the multilayer portion and an outer layer arranged opposite to the multilayer portion,
wherein the inner layer and the outer layer include a filler material, and
wherein an area ratio of the filler material in the outer layer is lower than an area ratio of the filler material in the inner layer, in a cross section including a stacking direction.

2. The all solid battery as claimed in claim 1,
wherein the inner layer is each of cover layers that respectively cover an uppermost end face and a lowermost end face of the multilayer portion in the stacking direction.

3. The all solid battery as claimed in claim 1,
wherein the inner layer is each of margin layers that are respectively arranged around each of the plurality of internal electrode layers on a main face of each of the plurality of solid electrolyte layers.

4. The all solid battery as claimed in claim 1,
wherein the filler material is alumina or silica.

5. The all solid battery as claimed in claim 1,
wherein the inner layer and the outer layer include a matrix material that is spatially and continuously formed and is made of oxide-based solid electrolyte or a glass material.

6. The all solid battery as claimed in claim 1,
wherein the inner layer and the outer layer include a matrix material that is spatially and continuously formed and is made of oxide-based solid electrolyte or a glass material that have a NASICON type crystal structure.
